(19) United States
(12) Patent Application Publication
(10) Pub. No.: US 2016/0202556 A1
(43) Pub. Date: Jul. 14, 2016

(54) LIQUID CRYSTAL DISPLAY

(71) Applicant: Samsung Display Co., Ltd., Yongin-si (KR)

(72) Inventors: Sang-Gu LEE, Hwaseong-si (KR); Ji-Hoon KIM, Hwaseong-si (KR); Seung Hee LEE, Hwaseong-si (KR); Kyung Hwan JEON, Hwaseong-si (KR)

(21) Appl. No.: 14/852,319

(22) Filed: Sep. 11, 2015

(30) Foreign Application Priority Data
Jan. 8, 2015 (KR) 1020150002721

(51) Int. Cl. G02F 1/13363; G02F 1/1339; G02F 1/1362; G02F 1/1335; G02F 1/1368

(52) U.S. Cl. CPC G02F 1/133634; G02F 1/133528; G02F 1/1368; G02F 1/136209; G02F 1/13394; G02F 2001/136222

(57) ABSTRACT

An exemplary embodiment of the present invention provides a liquid crystal display including: a first substrate and a second substrate which are opposite to each other, a liquid crystal layer which is interposed between the first substrate and the second substrate, a first polarizer which is disposed outside the first substrate and includes a reflective polarization film, a first compensation film which is disposed outside the second substrate and includes a biaxial film, and a second polarizer which is disposed outside the first compensation film, in which a thickness direction retardation value of the biaxial film is 300 nm to 380 nm.

### CROSS-REFERENCE TO RELATED APPLICATION

This application claims priority to and the benefit of Korean Patent Application No. 10-2015-0002721 filed in the Korean Intellectual Property Office on Jan. 8, 2015, the entire contents of which are incorporated herein by reference.

### BACKGROUND

(a) Technical Field

Provided is a liquid crystal display.

(b) Description of the Related Art

A liquid crystal display includes a liquid crystal panel which displays an image using light and a backlight assembly which is disposed below the liquid crystal panel to supply light to the liquid crystal panel.

The liquid crystal panel includes a first substrate having a thin film transistor and a pixel electrode, a second substrate which is opposite to the first substrate and has a common electrode, and a liquid crystal layer interposed between the first substrate and the second substrate.

Liquid crystal in the liquid crystal layer operates in a vertical alignment (VA) mode by an electric field formed between the pixel electrode and the common electrode. For example, when the electric field is not formed between the pixel electrode and the common electrode, the liquid crystal panel implements a black image, and when the electric field is formed between the pixel electrode and the common electrode, the liquid crystal panel implements several gray levels of images.

When the electric field is formed between the pixel electrode and the common electrode, an angle of the liquid crystals in the liquid crystal layer with respect to the pixel electrode or the common electrode is smaller than 90 degrees and the liquid crystal panel implements an image which is gradually brightened. When the liquid crystals are vertically arranged and light is straightly incident onto the front of the liquid crystal panel, an excellent black image having a low luminance is displayed, but when the light is incident to the side of the liquid crystal panel, the luminance of the black image is higher than that of the front of the liquid crystal panel. This is because since the light which travels to the side of the liquid crystal panel obliquely passes through the liquid crystal panel, the light undergoes retardation due to the liquid crystals, as compared with the light which travels to the front and is scattered when the light passes through the thin film transistor and a color filter so that a polarization state is changed to cause light leakage.

As described above, in the liquid crystal panel which operates in a vertical alignment (VA) mode, the luminance of the black image is high, so that a contrast ratio may be low.

The above information disclosed in this Background section is only for enhancement of understanding of the background of the invention and therefore it may contain information that does not form the prior art that is already known in this country to a person of ordinary skill in the art.

### SUMMARY

The embodiment of the present invention has been made in an effort to provide a liquid crystal display.

An object of one exemplary embodiment of the present invention is to improve a viewing angle of a vertical alignment (VA) mode liquid crystal display.

An exemplary embodiment of the present invention may be used to achieve another objects which are not specifically mentioned other than the above-mentioned object.

An exemplary embodiment of the present invention provides a liquid crystal display including: a first substrate and a second substrate which are opposite to each other, a liquid crystal layer which is interposed between the first substrate and the second substrate, a first polarizer which is disposed outside the first substrate and includes a reflective polarization film, a first compensation film which is disposed outside the second substrate and includes a biaxial film, and a second polarizer which is disposed outside the first compensation film, in which a thickness direction retardation value of the biaxial film is 300 nm to 380 nm.

Here, an in-plane retardation value of the biaxial film may be 45 nm to 75 nm.

Further, a thickness direction retardation value of the biaxial film may be 340 nm and the in-plane retardation value may be 65 nm.

The liquid crystal display may further include: a color filter which is disposed on the first substrate, a thin film transistor which is disposed on the first substrate, a pixel electrode which is connected to the thin film transistor, and a common electrode which is disposed on the second substrate, and the liquid crystal layer is arranged by a vertical electrical field which is generated between the pixel electrode and the common electrode.

The liquid crystal display may further include a light blocking member which is disposed on the first substrate.

The liquid crystal display may further include a spacer which is disposed between the first substrate and the second substrate.

Further, the first polarizer may include a first film and a second film and refractive indexes of an X-axis direction of the first film and the second film may be different from each other and refractive indexes of a Y-axis direction of the first film and the second film may be equal to each other.

The first polarizer may include a liquid crystal composition film in which a pitch is repeated along a spiral direction.

The first polarizer may include a diffuse-reflective polarization film.

The first polarizer may include a wire grid polarizer.

Another exemplary embodiment of the present invention provides a liquid crystal display including: a first substrate and a second substrate which are opposite to each other, a liquid crystal layer which is interposed between the first substrate and the second substrate, a first polarizer which is disposed outside the first substrate and includes a reflective polarization film, a second compensation film which is disposed outside the second substrate and includes a negative C-plate, a third compensation film which is disposed outside the second compensation film and includes a biaxial film, and a second polarizer which is disposed outside the third compensation film.

Here, a thickness direction retardation value of the biaxial film is 230 nm to 290 nm.

Further, an in-plane retardation value of the biaxial film is 45 nm to 75 nm.

A thickness direction retardation value of the biaxial film may be 260 nm and the in-plane retardation value may be 65 nm.

Further, a thickness direction retardation value of the negative C-plate may be 40 nm to 120 nm.

The thickness direction retardation value of the negative C-plate may be 80 nm.

The liquid crystal display may further include a color filter which is disposed on the first substrate, a thin film transistor which is disposed on the first substrate, a pixel electrode which is connected to the thin film transistor, and a common electrode which is disposed on the second substrate, and the liquid crystal layer may be arranged by a vertical electrical field which is generated between the pixel electrode and the common electrode.

The liquid crystal display may further include a light blocking member which is disposed on the first substrate.

The liquid crystal display may further include a spacer which is disposed between the first substrate and the second substrate.

Further, the first polarizer may include a first film and a second film and refractive indexes of an X-axis direction of the first film and the second film may be different from each other and refractive indexes of a Y-axis direction of the first film and the second film may be equal to each other.

According to an exemplary embodiment of the present invention, a viewing angle of a vertical alignment (VA) mode liquid crystal display may be improved.

### BRIEF DESCRIPTION OF THE DRAWINGS

FIG. 1 is a cross-sectional view illustrating a liquid crystal display according to an exemplary embodiment of the present invention.

FIG. 2 is a perspective view illustrating a structure of a reflective polarization film used for a liquid crystal display according to an exemplary embodiment of the present invention.

FIG. 3 is a view illustrating a Poincare spherical surface indicating a polarization stage in accordance with a light path in the liquid crystal display of FIG. 1.

FIG. 4 is a cross-sectional view illustrating a liquid crystal display according to an exemplary embodiment of the present invention.

FIG. 5 is a view illustrating a Poincare spherical surface indicating a polarization stage in accordance with a light path in the liquid crystal display of FIG. 4.

FIG. 6 is a simulation result indicating a luminance of a liquid crystal display in a black state according to a comparative example.

FIGS. 7 and 8 are simulation results indicating a luminance of a liquid crystal display in a black state according to an exemplary embodiment of the present invention.

### DETAILED DESCRIPTION OF THE EMBODIMENTS

The present invention will be described more fully hereinafter with reference to the accompanying drawings, in which exemplary embodiments of the invention are illustrated. As those skilled in the art would realize, the described embodiments may be modified in various different ways, all without departing from the spirit or scope of the present invention. Accordingly, the drawings and description are to be regarded as illustrative in nature and not restrictive and like reference numerals designate like elements throughout the specification. Further, detailed description of a well-known related art will be omitted.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In the meantime, when an element is referred to as being “directly on” another element, there are no intervening elements present. In contrast, it will be understood that when an element such as a layer, film, region, or substrate is referred to as being “under” another element, it can be directly below the other element or intervening elements may also be present. Further, when an element is referred to as being “directly below” another element, there are no intervening elements present.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

First, a liquid crystal display according to an exemplary embodiment of the present invention will be roughly described with reference to the accompanying drawings.

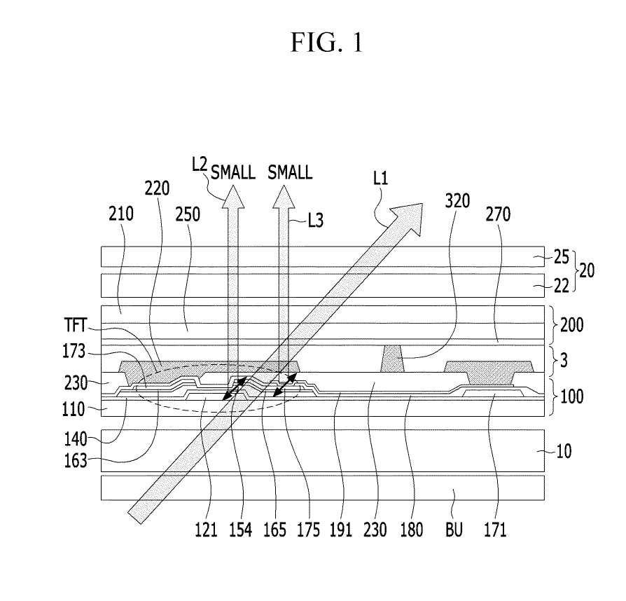

FIG. 1 is a cross-sectional view illustrating a liquid crystal display according to an exemplary embodiment of the present invention.

Referring to FIG. 1, a liquid crystal display according to an exemplary embodiment of the present invention includes a lower panel 100 and an upper panel 200 which are opposite to each other, a first polarizer 10 which is disposed outside the lower panel 100, and an optical unit 20 which is disposed outside the upper panel 200. The optical unit 20 includes a first compensation film 22 and a second polarizer 25.

The lower panel 100 includes a first substrate 110, a gate line 121 which is disposed on the first substrate 110 and includes a gate electrode, a gate insulating layer 140 which is disposed on the gate line 121, a semiconductor layer 154 which is disposed on the gate insulating layer 140, ohmic contacts 163 and 165 which are disposed on the semiconductor layer 154, a data line 171 which is disposed on the ohmic contacts 163 and 165 and includes a source electrode 173 and a drain electrode 175, a passivation layer 180 which is formed to cover the source electrode 173 and the drain electrode 175, a pixel electrode 191 which is disposed on the passivation layer 180, and a color filter 230 which is disposed on the pixel electrode 191. Differently from FIG. 1, the color filter 230 may be disposed below the pixel electrode 191.

A light blocking member 220 is disposed on the color filter 230. The light blocking member 220 is also referred to as a black matrix and prevents light leakage between the pixel electrodes 191. The light blocking member 220 may be disposed in a portion corresponding to the gate line 121 and the data line 171 and in a portion corresponding to the thin film transistor. The light blocking member 220 may be disposed between adjacent color filters 230.

As described above, in the liquid crystal display according to one exemplary embodiment of the present invention, the color filter 230 and the light blocking member 220 are disposed in the lower panel 100. However, the present invention is not limited thereto, but the color filter 230 may be disposed in the lower panel 100 and the light blocking member may be disposed in the upper panel 200.

The upper panel 200 includes an overcoat 250 disposed on the second substrate 210 and a common electrode 270 disposed on the overcoat 250. The common electrode 270 is formed of a transparent conductive material and is applied with a common voltage. The overcoat 250 may be omitted.

In the present exemplary embodiment, since the upper panel 200 does not have a pattern type structure, a scattering factor is completely removed, thereby minimizing leakage of light scattering from the front.

The liquid crystal display according to the present exemplary embodiment further includes a liquid crystal layer 3 interposed between the lower panel 100 and the upper panel 200. Further, a spacer 320 which maintains a cell gap of the liquid crystal layer 3 is disposed between the lower panel 100 and the upper panel 200. The spacer 320 may be formed of the same material as the light blocking member 220 and may be formed simultaneously with the light blocking member in the same process. However, the spacer 320 and the light blocking member 220 are not necessarily formed simultaneously and in the same process but may be formed of a different material or in a different process.

The gate electrode, the source electrode 173, and the drain electrode 175 form a thin film transistor (TFT) and the thin film transistor (TFT) is electrically connected to the pixel electrode 191. The pixel electrode 191 is formed of a transparent conductive material and is applied with a data voltage which is transmitted from the data line 171 through the thin film transistor (TFT).

The liquid crystal layer 3 may be driven in a vertical alignment mode. That is, in a state when an electric field is not formed between the pixel electrode 191 and the common electrode 270, the liquid crystals of the liquid crystal layer 3 are arranged in a vertical direction to a surface of the first substrate 110. When an electric field is formed between the pixel electrode 191 and the common electrode 270, the liquid crystals of the liquid crystal layer 3 are inclined with respect to the surface of the first substrate 110 and an inclined angle is increased as the strength of the electric field is increased and ultimately, the liquid crystals are arranged in a horizontal direction with respect to the surface of the first substrate 110.

The first polarizer 10 according to the exemplary embodiment of the present invention may be a reflective polarization film. Light which is generated from a light source BU disposed below the first polarizer 10 transmits the first polarizer 10 and is incident onto the lower panel 100.

In the case of an adsorptive polarizer containing polyvinyl alcohol, transmittance is less than 50%. Therefore, after the light passes through the first polarizer 10 which is disposed in the lower panel 100, optical efficiency is lowered to be half or lower. However, according to the present exemplary embodiment, instead of the existing adsorptive polarizer, the reflective polarization film is used, thereby improving the luminance. When the reflective polarization film is used as a polarizer, the light transmittance is improved by repeated light reflection, which results in increasing a luminance.

However, a polarization efficiency of the reflective polarization film may be deteriorated as compared with the existing adsorptive polarizer, which may be compensated by forming the first compensation film 22 by a biaxial film having a high thickness direction retardation value Rth in the upper panel 200 without forming a compensation film in the lower panel 100.

In the present exemplary embodiment, the reflective polarization film may have a structure in which a plurality of two films having refractive indexes in an X-axis direction which are different from each other and refractive indexes in a Y-axis direction which are equal to each other is laminated. Further, the reflective polarization film may have a structure in which a plurality of two films having refractive indexes in an X-axis direction which are equal to each other and refractive indexes in a Y-axis direction which is different from each other are laminated. In this structure, transmitting and reflecting effect varies depending on an axis direction to show polarization performance and a plurality of films may include polyethylene naphthalate (PEN).

As another example of a reflective polarization film, there is a liquid crystal composition film in which a pitch of a predetermined period is repeated along a spiral direction. Such a liquid crystal composition film transmits light which coincides with the spiral direction and reflects light in an opposite direction and then changes the transmitting light into rotation polarization using a λ/4 retarder.

As another example of the reflective polarization film, the reflective polarization film may be a diffuse-reflective polarization film. The diffuse-reflective polarization film is a film in which refractive indexes of the transmissive axis direction are same or similar, but refractive indexes in the reflective axis direction are different from each other, so that the film passes polarization in the transmissive axis direction and diffuses and reflects light in a direction vertical to the transmissive axis.

As another example of the reflective polarization film, the reflective polarization film may be a wire grid polarizer. The wire grid polarizer transmits light which is parallel to the polarization direction among the incident light and reflects another light.

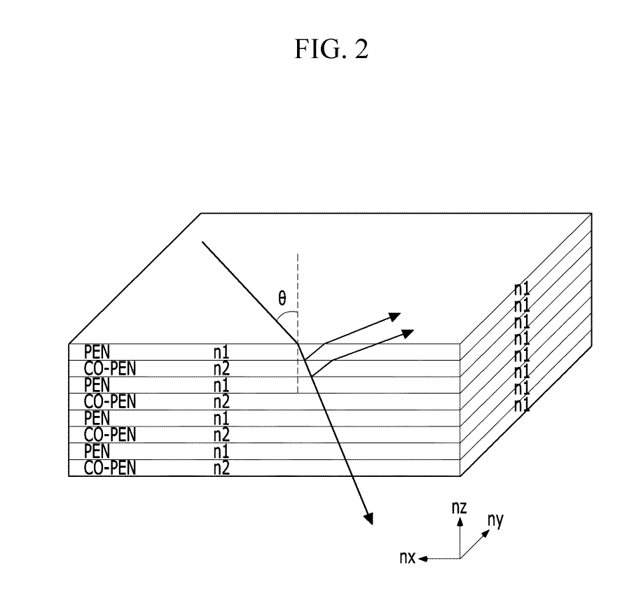

FIG. 2 is a perspective view illustrating a structure of a reflective polarization film used for a liquid crystal display according to an exemplary embodiment of the present invention.

Specifically, FIG. 2 illustrates a reflective polarizer which is formed of polyethylene naphthalene and has a structure in which a plurality of two films having different refractive indexes along the axis direction is laminated. The reflective polarizer of FIG. 2 has a structure in which a plurality of two films having different refractive indexes n1 and n2 in the X-axis direction and same refractive index n1 in the Y-axis direction is laminated. Further, the refractive index in X-axis direction may be different from the refractive index in the Y-axis direction. Films having different refractive indexes are alternately disposed so that the light is totally reflected and thus a recovery rate of the light may be increased.

The optical unit 20 includes a first compensation film 22 disposed outside the upper panel 200 and a second polarizer 25 disposed outside the first compensation film. The first compensation film 22 according to the exemplary embodiment of the present invention may be formed of a biaxial film.

Generally, the compensation film has refractive indexes nx, ny, and nz in x, y, and z axis directions and the biaxial film satisfies a relationship of refractive indexes of nx>ny>nz and a negative C-plate satisfies a relationship of refractive indexes of nx=ny>nz. Further, an in-plane retardation value Re and a thickness direction retardation value Rth are defined by Equation 1 and Equation 2 and d is a thickness of the compensation film.

Re=(nx−ny)*d [Equation 1]

Rth=((nx+ny)/2−nz)*d [Equation 2]

When the first compensation film 22 is configured by the biaxial film, the thickness direction retardation value Rth of the biaxial film may be 300 nm to 380 nm and the in-plane retardation value Re of the biaxial film may be 45 nm to 75 nm. Particularly, the thickness direction retardation value Rth of the biaxial film is more desirably 340 nm and the in-plane retardation value Re of the biaxial film is more desirably 65 nm.

The first compensation film 22 may be formed of at least one of tri-acetyl-cellulose (TAC), cyclic olefin polymer (COP) based and acryl based polymer resins. The acryl based polymer resin may include polymethylmethacrylate (PMMA).

The light which sequentially transmits the lower panel 100, the liquid crystal layer 3, and the upper panel 200 passes through the optical unit 20 to display the image.

Hereinafter, a path of the light which passes through the liquid crystal display according to one exemplary embodiment of the present invention will be described with reference to FIGS. 1 to 3.

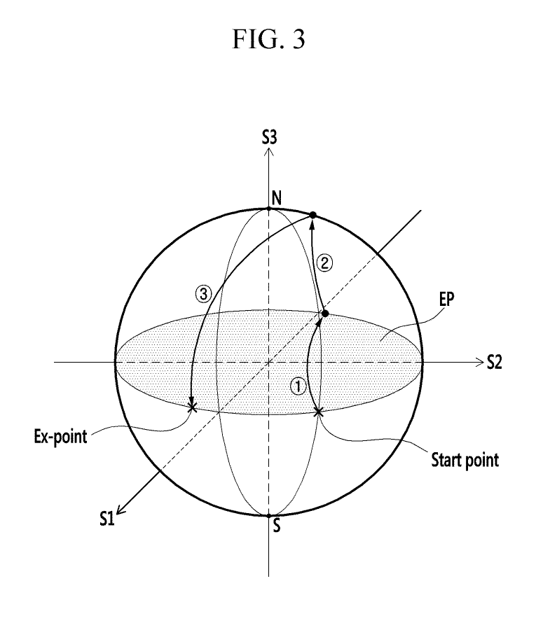

FIG. 3 is a view illustrating a Poincare spherical surface indicating a polarization stage in accordance with a light path in the liquid crystal display of FIG. 1.

Referring to FIGS. 1 and 3, when light L1 generated from a light source which is located below the first polarizer 10 passes through the first polarizer 10, a polarization state on a Poincare spherical surface moves along \textcircled{1} to be located between the north pole N and the equator EP. The light which passes through the first polarizer 10 is incident onto the lower panel 100 and is scattered into light L2 and L3 by the thin film transistor (TFT) and the color filter 230. Here, the scattered light L2 by the thin film transistor (TFT) and the scattered light L3 by the color filter 230 causes small amount of light leakage as compared with the scattering in a circular polarization state. Additionally, the light which passes through the first polarizer 10 may be scattered by the light blocking member 220 and the scattering pattern is similar to the scattering pattern caused by the thin film transistor (TFT) and the color filter 230. When light which passes through the lower display panel 100 passes through the liquid crystal layer 3, the polarization state on the Poincare spherical surface moves along \textcircled{2} to be very close to the north pole N. When the light which passes through the liquid crystal layer 3 is incident onto the upper panel 200 and the light which passes through the upper panel 200 passes through the first compensation film 22, the polarization state on the Poincare spherical surface moves along \textcircled{3} to reach an ex-point which is located on the equator EP of the Poincare spherical surface.

In the liquid crystal display according to the exemplary embodiment of the present invention which has been described with reference to FIGS. 1 and 3, through an optical design which forms the first polarizer 10 as a reflective polarization film in a structure in which the color filter 230 and the light blocking member 220 are disposed in the lower panel 100 and forms the first compensation film 22 disposed between the upper panel 200 and the second polarizer 25 as a biaxial film, the light leakage due to light scattered by the thin film transistor (TFT), the color filter 230, and the light blocking member 220 is minimized and a viewing angle characteristic may be improved from a specific range of the thickness direction retardation value Rth of the biaxial film.

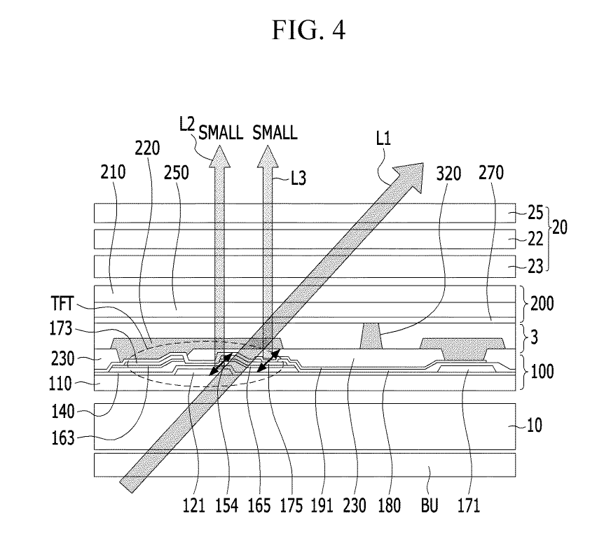

Hereinafter, a liquid crystal display according to another exemplary embodiment of the present invention, specifically, difference from FIG. 1 will be described with reference to FIG. 4.

FIG. 4 is a cross-sectional view illustrating a liquid crystal display according to an exemplary embodiment of the present invention.

An optical unit 20 includes a second compensation film 23 which is disposed outside an upper panel 200, a first compensation film 22 which is disposed outside the second compensation film, and a second polarizer 25 which is disposed outside the first compensation film 22. The second compensation film 23 according to the exemplary embodiment of the present invention may be configured by a negative C-plate and the first compensation film 22 may be configured by a biaxial film.

In the present exemplary embodiment, when the first compensation film 22 is configured by the biaxial film, the thickness direction retardation value Rth of the biaxial film may be 230 nm to 290 nm and the in-plane retardation value Re of the biaxial film may be 45 nm to 75 nm. Particularly, the thickness direction retardation value Rth of the biaxial film is more desirably 260 nm and the in-plane retardation value Re of the biaxial film is more desirably 65 nm.

When the second compensation film 23 is configured by the negative C-plate, the thickness direction retardation value Rth of the negative C-plate may be 40 nm to 120 nm. Particularly, the thickness direction retardation value Rth of the negative C-plate is more desirably 80 nm.

According to the exemplary embodiment of the present invention, the thickness direction retardation value Rth of the first compensation film which is configured by the biaxial film is relatively lowered and the second compensation film configured by the negative C-plate having reciprocal dispersion effect is used, thereby reducing dispersion of a wavelength. Therefore, a side contrast ratio (CR) may be improved.

The first compensation film 22 and the second compensation film 23 may be formed of at least one of tri-acetyl-cellulose (TAC), cyclic olefin polymer (COP) based and acryl based polymer resins. The acryl based polymer resin may include polymethylmethacrylate (PMMA).

Light generated from a light source BU disposed below the first polarizer 10 passes through the first polarizer 15 to be incident onto the lower panel 100 and light which sequentially passes through the lower panel 100, the liquid crystal layer 3, and the upper panel 200 passes through the optical unit 20 including the first compensation film 22 and the second compensation film 23 to display an image.

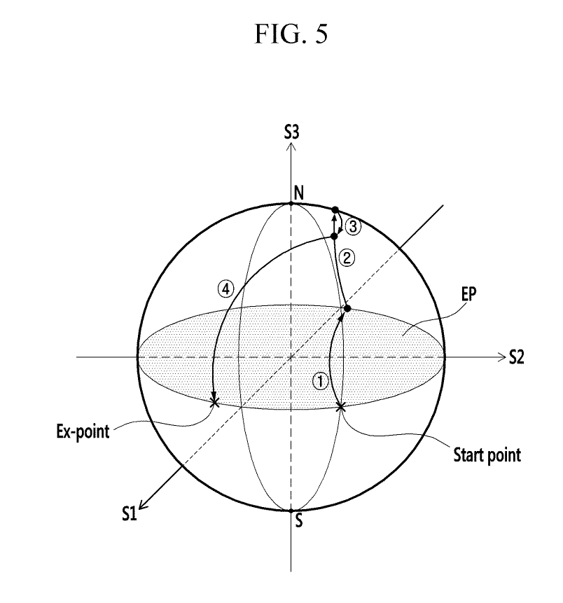

Hereinafter, a path of the light which passes through the liquid crystal display according to one exemplary embodiment of the present invention will be described with reference to FIGS. 4 and 5.

FIG. 5 is a view illustrating a Poincare spherical surface indicating a polarization stage in accordance with a light path in the liquid crystal display of FIG. 4.

Referring to FIGS. 4 and 5, when light L1 generated from the light source which is located below the first polarizer 10 passes through the first polarizer 10, a polarization state on a Poincare spherical surface moves along \textcircled{1} to be located between the north pole N and the equator EP. The light which passes through the first polarizer 10 is incident onto the lower panel 100 and is scattered into light L2 and L3 by the thin film transistor (TFT) and the color filter 230. Here, the scattered light L2 by the thin film transistor (TFT) and the scattered light L3 by the color filter 230 causes small amount of light leakage as compared with the scattering in a circular polarization state. Additionally, the light which passes through the first polarizer 10 may be scattered by the light blocking member 220 and the scattering pattern is similar to the scattering pattern caused by the thin film transistor (TFT) and the color filter 230. When light which passes through the lower panel 100 passes through the liquid crystal layer 3, the polarization state on the Poincare spherical surface moves along \textcircled{2} to be very close to the north pole N. When the light which passes through the liquid crystal layer 3 is incident onto the upper panel 200 and the light which passes through the upper panel 200 passes through the second compensation film 23, the polarization state on the Poincare spherical surface moves along \textcircled{3} to be slightly lowered in an opposite direction to \textcircled{2}. When the light which passes through the second compensation film 23 passes through the first compensation film 22, the polarization state on the Poincare spherical surface moves along \textcircled{4} to reach an ex-point which is located on the equator EP of the Poincare spherical surface.

In the liquid crystal display according to the exemplary embodiment of the present invention which has been described with reference to FIGS. 4 and 5, through an optical design which forms the first polarizer 10 as a reflective polarization film in a structure in which the color filter 230 and the light blocking member 220 are disposed in the lower panel 100 and forms the first compensation film 22 and the second compensation film 23 disposed between the upper panel 200 and the second polarizer 25 as a biaxial film and a negative C-plate, respectively, the light leakage due to light scattered by the thin film transistor (TFT), the color filter 230, and the light blocking member 220 is minimized and a viewing angle characteristic may be improved from a specific range of the thickness direction retardation values Rth of the biaxial film and the negative C-plate.

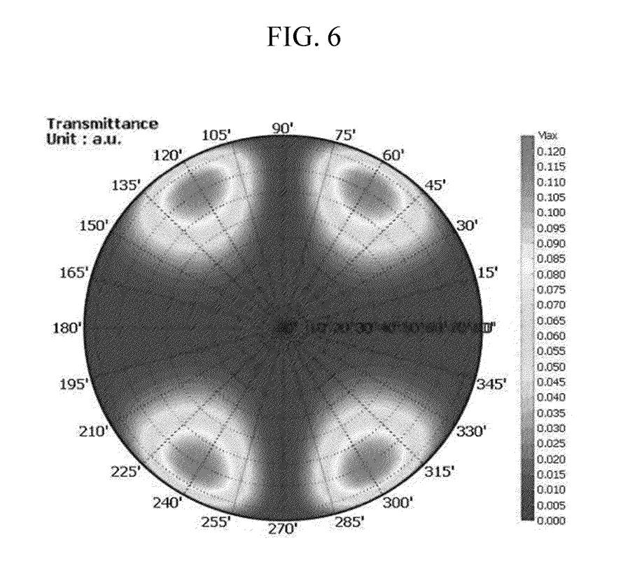

Hereinafter, a viewing angle characteristic of the liquid crystal display according to an exemplary embodiment of the present invention is compared with a viewing angle characteristic of a liquid crystal display according to a comparative example, with reference to FIGS. 6 to 8.

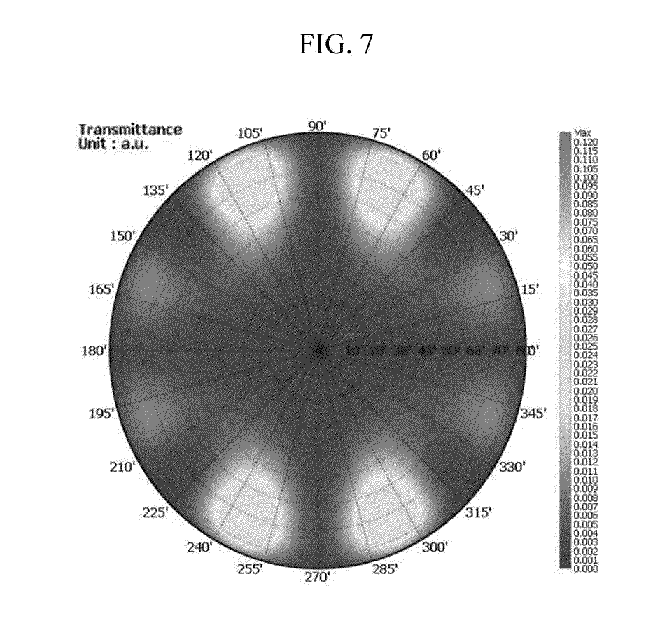

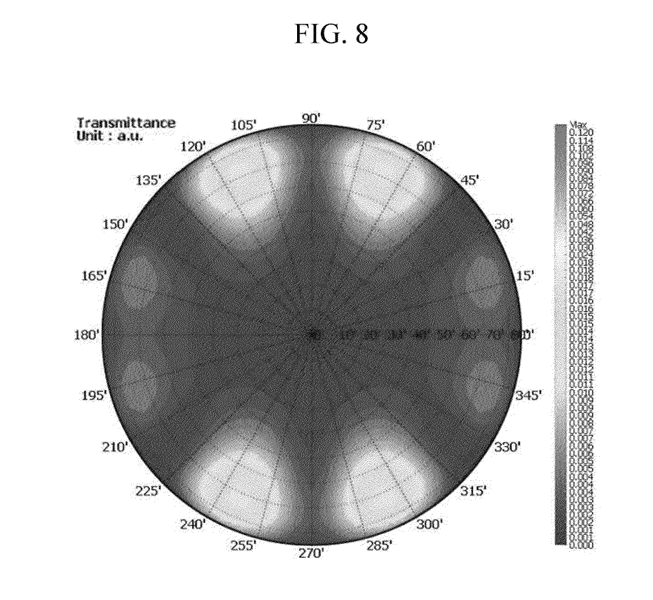

FIG. 6 is a simulation result indicating a luminance of a liquid crystal display in a black state according to a comparative example and FIGS. 7 and 8 are simulation results indicating a luminance of a liquid crystal display in a black state according to an exemplary embodiment of the present invention.

Referring to FIG. 6, in a structure in which the color filter 230 and the light blocking member 220 are disposed in the lower panel 100, the first polarizer 10 is formed as a reflective polarization film and the first compensation film 22 disposed between the upper panel 200 and the second polarizer 25 is formed as a biaxial film, but the thickness direction retardation value Rth of the biaxial film has a different range from the exemplary embodiment of the present invention. As seen from FIG. 6, when light is incident from a diagonal direction, light leakage of the liquid crystal display according to the comparative example which is in a black state is significantly increased. As seen from the simulation, a simulation result including red in a diagonal direction is seen, which is understood that the luminance of the liquid crystal display according to the comparative example in the black state is high. Therefore, the viewing angle characteristic of the liquid crystal display according to the comparative example is not good.

Referring to FIG. 7, similarly to FIG. 6, in a structure in which the color filter 230 and the light blocking member 220 are disposed in the lower panel 100, the first polarizer 10 is formed as a reflective polarization film and the first compensation film 22 disposed between the upper panel 200 and the second polarizer 25 is formed as the biaxial film. However, the thickness direction retardation value Rth of the biaxial film is 300 nm to 380 nm, similarly to the exemplary embodiment of the present invention. As seen from FIG. 7, when the light is incident to the diagonal direction, only green simulation result is seen in the diagonal direction on the simulation, which is understood that the luminance of the liquid crystal display according to the exemplary embodiment in the black state is low. Therefore, the viewing angle characteristic of the liquid crystal display according to the exemplary embodiment is improved.

Referring to FIG. 8, in a structure in which the color filter 230 and the light blocking member 220 are disposed in the lower panel 100, the first polarizer 10 is formed as a reflective polarization film and the first compensation film 22 and the second compensation film 23 disposed between the upper panel 200 and the second polarizer 25 are formed as the biaxial film and the negative C-plate, respectively. As seen from FIG. 8, when the light is incident to the diagonal direction, only green simulation result is seen in the diagonal direction on the simulation, which is understood that the luminance of the liquid crystal display according to the exemplary embodiment in the black state is low. Therefore, the viewing angle characteristic of the liquid crystal display according to the exemplary embodiment is improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 3: Liquid crystal layer | 10: First polarizer |
| 20: Second optical unit | 22: First compensation film |
| 23: Second compensation film | 25: Second polarizer |
| 100: Lower panel | 110: First substrate |
| 121: Gate line | 140: Gate insulating layer |
| 154: Semiconductor layer | 163, 165: Ohmic contact |
| 171: Data line | 173: Source electrode |
| 175: Drain electrode | 180: Passivation layer |
| 191: Pixel electrode | 200: Upper panel |
| 210: Second substrate | 220: Light blocking member |
| 230: Color filter | 250: Overcoat |
| 270: Common electrode | 320: Spacer |

What is claimed is:

1. A liquid crystal display, comprising:
a first substrate and a second substrate which are opposite to each other;
a liquid crystal layer which is interposed between the first substrate and the second substrate;
a first polarizer which is disposed outside the first substrate and includes a reflective polarization film;
a first compensation film which is disposed outside the second substrate and includes a biaxial film; and
a second polarizer which is disposed outside the first compensation film,
wherein a thickness direction retardation value of the biaxial film is 300 nm to 380 nm.

2. The liquid crystal display of claim 1, wherein:
an in-plane retardation value of the biaxial film is 45 nm to 75 nm.

3. The liquid crystal display of claim 2, wherein:
a thickness direction retardation value of the biaxial film is 340 nm and the in-plane retardation value is 65 nm.

4. The liquid crystal display of claim 1, further comprising:
a color filter which is disposed on the first substrate;
a thin film transistor which is disposed on the first substrate;
a pixel electrode which is connected to the thin film transistor; and
a common electrode which is disposed on the second substrate,
wherein the liquid crystal layer is arranged by a vertical electrical field which is generated between the pixel electrode and the common electrode.

5. The liquid crystal display of claim 4, further comprising:
a light blocking member which is disposed on the first substrate.

6. The liquid crystal display of claim 5, further comprising:
a spacer which is disposed between the first substrate and the second substrate.

7. The liquid crystal display of claim 1, wherein:
the first polarizer includes a first film and a second film and refractive indexes of an X-axis direction of the first film and the second film are different from each other and refractive indexes of a Y-axis direction of the first film and the second film are equal to each other.

8. The liquid crystal display of claim 1, wherein:
the first polarizer includes a liquid crystal composition film in which a pitch is repeated along a spiral direction.

9. The liquid crystal display of claim 1, wherein:
the first polarizer includes a diffuse-reflective polarization film.

10. The liquid crystal display of claim 1, wherein:
the first polarizer includes a wire grid polarizer.

11. A liquid crystal display, comprising:
a first substrate and a second substrate which are opposite to each other,
a liquid crystal layer which is interposed between the first substrate and the second substrate;
a first polarizer which is disposed outside the first substrate and includes a reflective polarization film;
a second compensation film which is disposed outside the second substrate and includes a negative C-plate;
a third compensation film which is disposed outside the second compensation film and includes a biaxial film; and
a second polarizer which is disposed outside the third compensation film.

12. The liquid crystal display of claim 11, wherein:
a thickness direction retardation value of the biaxial film is 230 nm to 290 nm.

13. The liquid crystal display of claim 12, wherein:
an in-plane retardation value of the biaxial film is 45 nm to 75 nm.

14. The liquid crystal display of claim 13, wherein:
a thickness direction retardation value of the biaxial film is 260 nm and the in-plane retardation value is 65 nm.

15. The liquid crystal display of claim 11, wherein:
a thickness direction retardation value of the negative C-plate is 40 nm to 120 nm.

16. The liquid crystal display of claim 15, wherein:
the thickness direction retardation value of the negative C-plate is 80 nm.

17. The liquid crystal display of claim 11, further comprising:
a color filter which is disposed on the first substrate;
a thin film transistor which is disposed on the first substrate;
a pixel electrode which is connected to the thin film transistor; and
a common electrode which is disposed on the second substrate,
wherein the liquid crystal layer is arranged by a vertical electrical field which is generated between the pixel electrode and the common electrode.

18. The liquid crystal display of claim 17, further comprising:
a light blocking member which is disposed on the first substrate.

19. The liquid crystal display of claim 18, further comprising:
a spacer which is disposed between the first substrate and the second substrate.

20. The liquid crystal display of claim 11, wherein:
the first polarizer includes a first film and a second film and refractive indexes of an X-axis direction of the first film and the second film are different from each other and refractive indexes of a Y-axis direction of the first film and the second film are equal to each other.
